(19) United States
(12) Patent Application Publication
(10) Pub. No.: US 2005/0068558 A1
(43) Pub. Date: Mar. 31, 2005

(54) Method and system to automatically update in real-time a printer driver configuration

(76) Inventors: Jianxin Wang, Trabuco Canyon, CA (US); Truc Nguyen, San Diego, CA (US); Vincent Wu, Irvine, CA (US); Rohit Wadhwa, Tustin, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/674,661

(22) Filed: Sep. 30, 2003

(51) Int. Cl. G06F 3/12; G06F 15/00; G06F 9/44

(52) U.S. Cl. 358/1.13; 719/327; 717/168

(57) ABSTRACT

The present invention is directed to a method and system for automatically and continuously updating a printer driver configuration. A first computer program residing on a controller, which acts to monitor the printer configuration, is activated. The printer configuration is read from the controller configuration and updates the DEVMODE data. The detection of a change in any attribute of the printer configuration causes a second program to activate. DEVMODE data is updated using a data layout described in an XML file. The data layout in the XML file will be packaged with the controller during building, as well as available on a CD-ROM, other portable device, or stored on a central location and accessed over a computer network for the updating printer drivers on the controller when new versions are released. The second program retrieves current printer configuration data using SNMP communications and writes this data to the registry. The registry is then updated by the second computer program using to account for the changes detected by the first computer program in accordance with the data layout of the XML file.

### BACKGROUND OF THE INVENTION

The present invention pertains generally to printer driver configurations. More particularly, the present invention is related to automatically updating a printer configuration.

Current printer drivers save the printer configuration details like the installed finisher, pedestal, cassette paper size and media type in the private DEVMODE area of the DEVMODE structure. The DEVMODE data structure contains information about the initialization and environment of a printer or a display device. The printer driver may not behave properly if this information is not correct. These details may be updated manually by the printer driver administrator from the printer driver user-interface, or by the dynamic update feature. But when the drivers are downloaded from the controller, this configuration cannot be changed, as controller does not have a printer driver administrator, and also the dynamic update feature does not work on the drivers installed on a controller. So drivers installed using the point and print feature may not reflect the actual configuration of the printer attached to the controller. A program may be written to update the printer configuration data in the controller, but as the data layout may change between printer driver versions, the problem will keep recurring.

Printer configuration such as paper cassette information or the type of finishers attached to the printer, e.g., stapler, hole punch, or the like, can be acquired through SNMP and displayed in the printer driver Properties Page upon the user's request, simply by pressing a push button. For a driver downloaded from an NT-based controller to an NT, Windows 2000, or Windows XP Client, i.e., point and print, the user may still be able to update the printer configuration as shown in the driver Properties Page, however the settings will not be saved unless the user has the administrator's rights to the controller. More importantly, the graphical user interface of the driver installed in the controller is inaccessible to the user; therefore the printer configuration as shown in the Properties Page cannot be updated through the driver graphical user interface. As a result, the printer configuration displayed in the Properties Page of such downloaded driver will be incorrect if any printer settings have been changed.

Thus there is a need for a method and system to continuously and automatically update, in real-time, a printer driver configuration.

### SUMMARY OF THE PRESENT INVENTION

In accordance with the present invention, there is provided a system and method for automated updating of printer drivers associated with a printer configuration.

Further, in accordance with the present invention, there is provided a method and system for automatically updating a printer driver associated with a printer configuration. The method begins by initializing the controller and retrieving current printer configuration from a registry on a controller. An external file containing at least one offset representative of a respective at least one printer attribute is then accessed. Next, the at least one offset representative of the respective at least one printer attribute is queried, thereby retrieving the offsets necessary to advance to the updating step. The data structure containing information about initialization and environment of a printer, that is the DEVMODE data, is subsequently updated. The external file may then be copied to the controller for future access.

In a preferred embodiment, the at least one offset representative of the at least one printer attribute is stored on a portable storage media. In a preferred embodiment, the offsets are in an extensible markup language file.

Still further, in accordance with the present invention, there is provided a system for automatically updating a printer driver associated with a printer configuration. The system comprises means adapted for initializing the controller and retrieving current printer configuration from a registry on a controller, means adapted for accessing an external file containing at least one offset representative of a respective at least one printer attribute, means adapted for querying the at least one offset representative of the respective at least one printer attribute, means adapted for updating the DEVMODE data, information about initialization and environment of a printer, and means adapted for copying the external file to the controller for future access.

In a preferred embodiment, the at least one offset representative of the at least one printer attribute is stored on a portable storage media, such as a CD-ROM or the like. In a preferred embodiment, the offsets are in an extensible markup language file.

Yet further, in accordance with the present invention, there is provided a method for automatically updating a printer driver associated with a printer configuration. The method begins by initiating a first computer program stored on a controller. The program retrieves printer data for a current printer configuration from a registry. The program then monitors the current configuration for any attribute change. Upon the detection of an attribute change, a second program is initiated. The first computer program monitors the registry, looking for keys having a change in value and notifies a caller when a change in the value or content of any specific registry key has changed. The registry keys are then reset to a non-signaled state. The second program retrieves the current printer configuration via a communications protocol, such as simple network management protocol. The retrieved configuration is then written to a registry key. A printer driver associated with the identified registry key is then automatically updated to correspond to the change in value or content of that registry key.

Still yet further, in accordance with the present invention, there is provided a system for automatically and continuously updating a printer driver. The system comprises a first computer program and a second computer program. The first computer program includes means adapted for retrieving printer data for a current printer configuration from a registry, and means adapted for monitoring the current printer configuration for an attribute change. The second computer program, residing on the controller, is activated by the first computer program in response to the attribute change. The first program also includes means adapted for monitoring registry keys associated with printer drivers and means adapted for notifying a caller of the change detected in the registry keys. The first program further provides means adapted for resetting the registry key values to a non-signal state. The system also comprises means adapted for activating a second computer program, which retrieves the current printer configuration via a communications protocol, such as simple network management protocol. Means adapted for writing the current printer configuration to a specific registry key are also provided in the second computer program. Also provided for in the second computer program is means adapted for automatically updating a printer driver associated with the identified registry key, corresponding to the change in value or content of that registry key.

Additional objects, advantages and novel features of the invention will be set forth in part in the description which follows, and in part will become apparent to those skilled in the art upon examination of the following or may be learned by practice of the invention. The objects and advantages of the invention may be realized and attained by various structures and methods as covered by the patent claims.

### BRIEF DESCRIPTION OF THE DRAWINGS

The accompanying figures incorporated in and forming a part of the specification, illustrates several aspects of the present invention, and together with the description serve to explain the principles of the invention. In the figures:

FIG. 1 is an flow chart depicting a printer driver update method of the present invention;

FIG. 2 is a flow chart illustrating a thread execution program configuration monitoring envisioned in the present invention;

FIG. 3 is a flow chart depicting packaging XML file during controller build;

FIG. 4 is a flow chart depicting packaging XML file during client build;

FIG. 5 is a flow chart illustrating an application program configuration update component;

FIG. 6 is a flow chart illustrative of a DEVMODE update upon controller initialization; and

FIG. 7 is a flow chart depicting a printer driver update on a controller.

### DETAILED DESCRIPTION OF PREFERRED AND ALTERNATE EMBODIMENTS

The present invention is described below as a method invoked upon a computer system. Directed to a printer and printer-controller, the present invention pertains to the automatic and continuous updating of printer drivers and the like. As used herein, the printer-controller, or controller, is communicatively coupled to an image forming apparatus, and acts to control and operate the image forming apparatus. A printer driver is any computer driver known in the art pertaining to the control, processing, or the like, of an image forming apparatus.

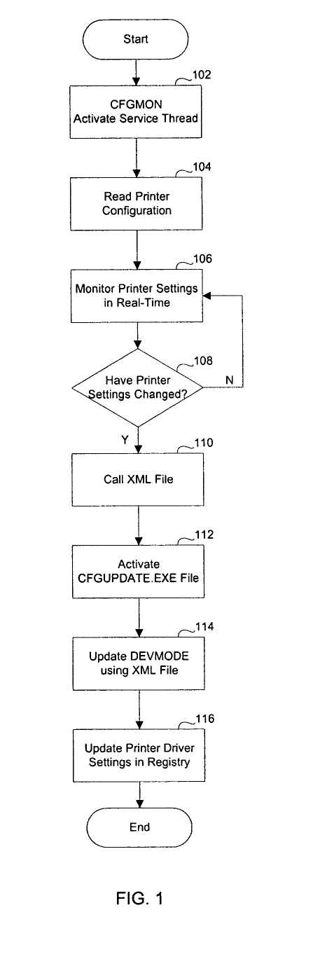

Turning to FIG. 1, there is shown a flow chart demonstrative of the method envisioned by the present invention. The method begins at step 102 by activating the configuration monitoring service thread. The configuration monitoring service thread is one of many threads comprising JOBCON, a workspace that creates the Network Print Job Control service. The configuration monitoring component monitors registry keys for any changes related to printer configuration. The configuration monitoring thread opens the registry keys and waits for any attribute changes through the Windows API RegNotifyChangeKeyValue. Having activated the configuration monitoring service thread, the method proceeds to read the current printer configuration at step 104. Once the current printer configuration has been read, the configuration monitoring component monitors the printer settings in real-time at step 106.

While monitoring the printer settings, the configuration monitoring component waits until the printer settings have changed. At step 108, the method determines if the printer settings have changed. In the event that the printer settings have not changed since activation of the configuration monitoring component, or the last controller shutdown, the method directs back to step 106, where the configuration monitoring component monitors printer settings. Upon the positive determination that the printer settings have changed at step 108, the method directs the system to call an extensible markup language, or XML, file containing DEVMODE information at step 110. A configuration update program is then executed at 1112. The configuration update component enables the retrieval of the current printer configuration through SNMP and writes it the PrinterDriverData key in the Windows Registry. Subsequently, the DEVMODE structure is updated at 114 using the information stored in the called XML file. The printer driver settings in the registry are then updated at 116.

Having thus briefly explained the method, the following more detailed description of the component parts will demonstrate to one of skill in the art the operation of the present invention.

Configuration Monitoring Thread Execution

In a preferred embodiment, the configuration monitoring component is that component of the present invention that operates on the controller and acts to monitor the printer settings in a real-time capacity. While discussed herein as a configuration monitoring component, one skilled in the art will appreciate that any suitable computer implemented instruction may be used to monitor the printer settings. In its most basic form as contemplated by the present invention, the configuration monitoring component opens the registry keys and waits for any attribute change. An attribute change is a SET event occurring in the system. An event is SET when a registry key change is successful. Whenever an event is SET, the configuration monitoring component invokes the configuration update component of the present invention.

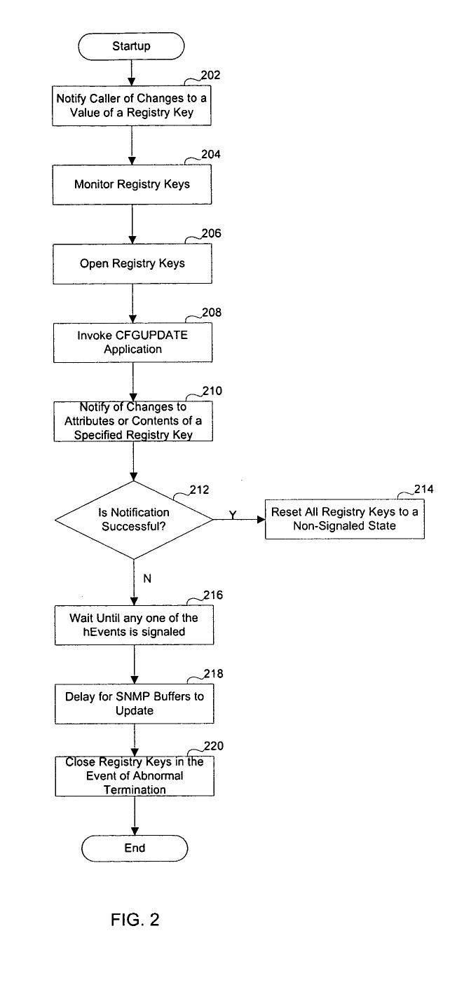

Turning now to FIG. 2, there is illustrated an embodiment representative of the capabilities of the monitoring component. It will be appreciated by those skilled in the art that for purposes of explanation, an event has occurred. Based on this pretext, upon controller start-up, the configuration monitoring component is activated. In order to read the printer configuration and monitor the printer settings, the configuration monitoring component completes the following steps. The configuration monitoring component then proceeds to notify a caller of changes to a value of the registry key at 202. At 204, the configuration monitoring component monitors the keys, seeking any changes that may have been made since last check. The registry keys are opened at 206, which enables the configuration monitoring component to detect that a change has been made to the printer settings.

At 208, the configuration update component, referred to as CFGUPDATE.EXE in FIG. 2, is invoked, operating as described below. Having detected the change in any attribute of the printer registry keys, the configuration monitoring component progresses to notify the caller of changes to attributes or contents of any specified registry key at 210. A notification successful determination at step 212 allows the reset of all registry keys to a non-signal state at step 214. An unsuccessful notification determination at 212 instructs the configuration monitoring component to wait at 216 until any one of hEvents is signaled. A delay, to allow for SNMP buffers to update, is inserted at 218. The registry keys are then closed in the event of an abnormal termination of configuration monitoring component at 220.

Printer configuration, such as paper cassette settings and the types of finishers attached to the printer, are stored in the controller Windows registry. The driver Properties Page displays the printer configuration information that is saved in the form of PrinterStickies as a part of the private printer data or extended DEVMODE data structure. A copy of the extended DEVMODE can be found in the PrinterDriverData key of the controller Windows registry. The configuration update component resides in the controller. When evoked by the configuration monitoring component, the configuration update component retrieves the current printer configuration through simple network management protocol and writes it to the PrinterDriverData key in the registry. The printer driver PrinterStickies associated with the printer configuration get updated subsequently.

As a user opens the Properties Page of a printer driver downloaded from the controller to a Windows NT, Windows 2000 or Windows XP client, all the PrinterStickies of the driver installed in the controller will be pushed down to the downloaded driver, therefore the Properties Page of the Point-and-Print driver will always display the current printer configuration. It will be appreciated by those skilled in the art that the detailed description of a preferred embodiment of the configuration update component, discussed below, is for exemplification purposes only. The skilled artisan will appreciate that the configuration of the configuration update component program may be changed in accordance with the controller operating system, or type of printer, multifunction peripheral device or the like, used by the system.

XML File

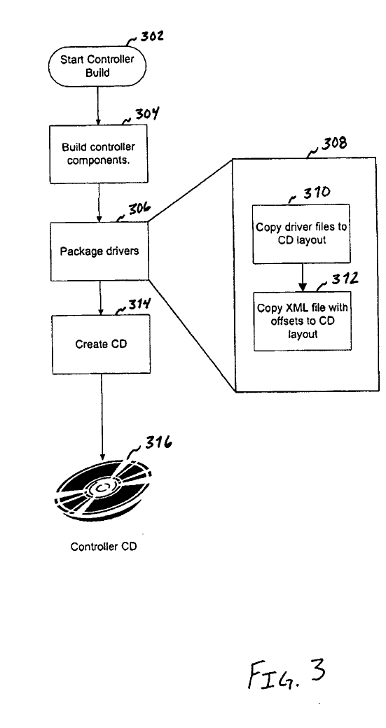

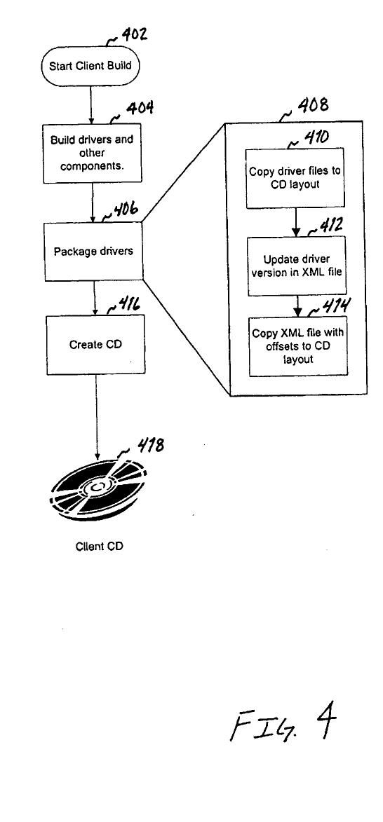

Upon initialization of the controller and subsequent confirmation of controller services, the configuration monitoring component detects at least one change in the printer settings. The method of the present invention then calls an extensible markup language, or XML, file following the detection of a change in the printer settings. The XML file is then queried for offsets of the various printer attributes contained in the controller registry. In a preferred embodiment, the XML file is contained on an external CD-ROM, but need not be so limited. Using the offsets thus retrieved from the XML file, the program updates the private DEVMODE of the printers installed on the controller. The XML file contains information necessary to facilitate the updating of the DEVMODE data structure. This information is conceptualized in the form of offsets of various printer attributes. As contemplated by the present invention, the XML file or files, one for each driver, may be incorporated into a controller CD-ROM during the building of the controller, as shown in FIG. 3, or incorporated into a client CD-ROM during the building of a client, as shown in FIG. 4.

Turning first to FIG. 3, there is shown a flow chart depicting the incorporation of the XML files onto a CD-ROM during the building of the controller. One of skill in the art will appreciate that controller may, but need not be limited to, a printer controller, a printer, a server, or other control device for a multifunction peripheral device. At 302, the controller build process is begun. The components of the controller are assembled at 304. Such assembly includes the software building, including the building of the necessary drivers to operate the multifunction peripheral device or printer to which the drivers relate. The drivers for the printer associated with the controller are then packaged at 306. This packaging of the drivers, as shown at 308 includes, but need not be limited to, the copying of driver files to a CD-ROM at 310 and the copying of an XML file with offsets to the CD-ROM layout at 312. The drivers and XML filer are then used in the creation of the CD-ROM at step 314 and the controller CD-ROM is generated at 316. It will now be appreciated that the use of a CD-ROM in conjunction with the XML file is used for exemplification purposes only. One of skill in the art will appreciate that the XML files may be incorporated into the method of present invention by other means, such means including, but not limited to, servers, Internet or intranet, floppy disk, or other means of transferring updated files.

Turning next to FIG. 4, there is shown the generation of a CD-ROM representative of the client build process. The client build process begins at 402 and continues to 404, where the drivers are built. Next, the drivers are packaged at 406. The packaging 408, includes, but need not be limited to, copying the driver files to the CD layout at 410, updating the driver version in the XML file at 412 and copying the XML file with offsets to the CD-ROM layout at 414. The foregoing are used to create the CD-ROM in 416 to generate the client CD-ROM 418. It will be apparent to one skilled in the art that private DEVMODE offsets should be published for each printer driver. The offsets are included in the aforementioned XML file. In the event that between driver versions, the private DEVMODE data layout changes, the XML file would require updating. Furthermore, as a result of packaging the XML file with the client CD-ROM, the XML file is accessible from the client driver repository, so that the controller build process may copy the XML file during the controller build.

CFGUPDATE Application Component

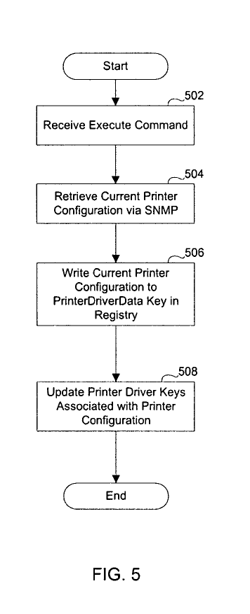

After calling the XML file, the method proceeds to invoke the configuration update component, which acts to update several aspects of the printer configuration. The configuration update component is a console application that updates related printer driver private data segments stored in the Windows registry of the controller with the most current printer settings. Turning to FIG. 5, there is shown a flow chart depicting the configuration update application component of the present invention. Beginning at 502, the configuration update component receives an execute command from the configuration monitoring component to retrieve the current printer configuration through SNMP at step 504. The configuration update component retrieves multiple attributes and settings of the current printer configuration, including, but not limited to, the printer driver handle, the byte pointer-printer data, the printer registry key type, the printer data size, the bytes read from the printer and the printer access structure. The configuration update component further retrieves such information as paper size and media types available from the printer. For example, the contents of the upper cassette/drawer, the lower cassette/drawer, the first pedestal, the second pedestal and the like are retrieved.

The configuration update component then writes the current printer configuration to the PrinterDriverData key in the registry at 506. The configuration update component may also retrieve printer data from the controller registry at this time. The specified printer driver is opened, i.e., the registry key is opened in accordance with configuration monitoring component, as described above, and processed. The printer driver keys associated with the printer configuration are then updated at 508. The updated printer driver keys are then returned to configuration monitoring component for further processing in accordance with the present invention.

DEVMODE Update on Controller Initialization

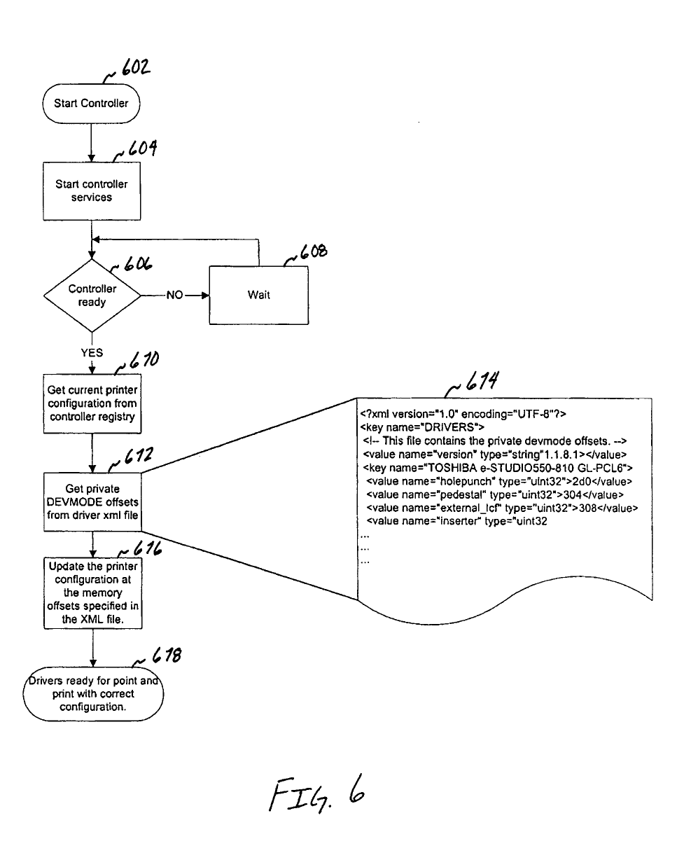

The DEVMODE structure of the controller must now be updated. This update is accomplished using the information contained in the XML file on the controller CD-ROM, the client CD-ROM, or via the various other means for retrieving stored files, as discussed above. Turning now to FIG. 6, there is shown a flow chart depicting the retrieval process involved in accessing the DEVMODE update information stored in the XML file. Upon controller startup at 602, the updating of the DEVMODE structure by the XML file progresses to the controller services startup at 604. A negative determination at 606 where the controller is not yet ready to begin services leads this component to wait at 608 for completion of controller startup.

A positive determination at 606 allows the update to get current printer configuration data from the controller registry at 610. At 612, the Private DEVMODE offsets from the driver XML file are retrieved. The sub process involved in retrieving the DEVMODE offsets from the XML file are exemplified at 614, which depicts a set of code containing the private DEVMODE offsets. One of skill in the art will appreciate that the contents of the file are demonstrative in nature and need not limit the present invention to the file type and content shown. After retrieving the XML file, the printer configuration is updated in 616 at the memory offsets specified in the XML file. Thus, the drivers are ready at 618 for point and print operations with the correct configuration.

Printer Driver Registry Update

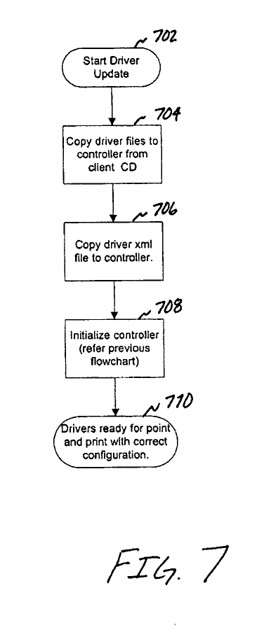

After having retrieved the required updates, as well as enabling the various components of the method envisioned by the present invention, the automatic configuration update proceeds to update the printer driver settings in the Windows Registry. Turning now to FIG. 7, there is shown an illustrative flow chart demonstrating the update process of the registry printer driver settings. Beginning at driver update start 702, the driver files are copied from the client CD-ROM to the controller at 704. Subsequently, the driver XML files are copied at 706 to the controller. The controller is then initialized at 706 in accordance with the method described above, referencing FIG. 6. After completing the update in accordance with the methods described herein, the drivers are ready for point and print with the correct, new configuration at 710.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skilled in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

1. A method for continuously updating a printer driver associated with a printer configuration, the steps comprising:
retrieving current printer configuration from a registry on a controller;
accessing an external file containing at least one offset representative of a respective at least one printer attribute;
querying the at least one offset representative of the respective at least one printer attribute; and
updating a data structure containing information about initialization and environment of a printer.

2. The method of claim 1, further comprising the step of initializing the controller.

3. The method of claim 1, further comprising the step of copying the external file containing at least one offset representative of a respective at least one printer attribute to the controller.

4. The method of claim 1, wherein the external file is an extensible markup language file.

5. The method of claim 1, further comprising the step of packaging the external file on a portable storage medium.

6. The method of claim 5, wherein the portable storage medium is packaged during a client build.

7. The method of claim 5, wherein the portable storage medium is packaged during a controller build.

8. The method of claim 1, wherein the updating a data structure step further comprises updating a private DEVMODE.

9. A system for automatically updating a printer driver associated with a printer configuration, comprising:
means adapted for retrieving current printer configuration from a registry on a controller;
means adapted for accessing an external file containing at least one offset representative of a respective at least one printer attribute;
means adapted for querying the at least one offset representative of the respective at least one printer attribute; and
means adapted for updating a data structure containing information about initialization and environment of a printer.

10. The system of claim 9, further comprising means adapted for initializing the controller.

11. The system of claim 9, further comprising means adapted for copying the external file containing at least one offset representative of a respective at least one printer attribute to the controller.

12. The system of claim 9, wherein the external file is an extensible markup language file.

13. The system of claim 9, further comprising means adapted for packaging the external file on a portable storage medium.

14. The system of claim 13, wherein the portable storage medium is packaged during a client build.

15. The system of claim 13, wherein the portable storage medium is packaged during a controller build.

16. The system of claim 9, wherein the means adapted for updating a data structure further comprises means adapted for updating a private DEVMODE.

17. A method for automatically updating a printer driver associated with a printer configuration, the steps comprising:
initiating a first computer program;
retrieving printer data for a current printer configuration from a registry;
monitoring the current printer configuration for an attribute change; and
activating a second computer program in response to the attribute change.

18. The method of claim 17, wherein the first computer program resides on a controller communicatively coupled to a printer.

19. The method of claim 17, the first computer program step further comprising:
monitoring at least one registry key for attribute changes; and
notifying a caller of a change to the attribute of the at least one registry key.

20. The method of claim 19, further comprising the step of resetting the at least one registry key to a non-signaled state.

21. The method of claim 17, the second computer program step further comprising:
retrieving a current printer configuration by a communications protocol;
writing the current printer configuration to at least one registry key; and
updating the printer driver associated with the at least one registry key.

22. The method of claim 21, wherein the communications protocol is simple network management protocol.

23. The method of claim 22, further comprising the step of delaying the simple network management protocol.

24. The method of claim 17, wherein the second computer program resides on a controller.

25. A system for automatically updating a printer driver associated with a printer configuration in real time, comprising:
a first computer program, including:
means adapted for retrieving printer data for a current printer configuration from a registry, and
means adapted for monitoring the current printer configuration for an attribute change; and
a second computer program, wherein the second computer program is activated by the first computer program in response to the attribute change.

26. The system of claim 25, wherein the first computer program resides on a controller communicatively coupled to a printer.

27. The system of claim 25, the first computer program further comprising:
means adapted for monitoring at least one registry key for attribute changes; and
means adapted for notifying a caller of a change to the attribute of the at least one registry key.

28. The system of claim 27, further comprising means adapted for resetting the at least one registry key to a non-signaled state.

29. The system of claim 25, the second computer program further comprising:
means adapted for retrieving a current printer configuration by a communications protocol;
means adapted for writing the current printer configuration to at least one registry key; and
means adapted for updating the printer driver associated with the at least one registry key.

30. The system of claim 29, wherein the communications protocol is a simple network management protocol.

31. The system of claim 30, the first computer program further comprising means adapted for delaying the simple network management protocol.
